(19) United States
(12) Patent Application Publication
(10) Pub. No.: US 2014/0065315 A1
(43) Pub. Date: Mar. 6, 2014

(54) BIAXIALLY ORIENTED BIO-BASED POLYOLEFIN FILM THAT HAS BEEN EXTRUSION COATED WITH BIO-BASED SEALANT FOR LIDDING APPLICATIONS

(71) Applicant: TORAY PLASTICS (AMERICA), INC., N. Kingstown, RI (US)

(72) Inventors: Roberto SIU, Providence, RI (US); Gordon Vincent Sharps, N. Kingstown, RI (US); Stefanos L. Sakellarides, East Greenwich, RI (US); Keunsuk P. Chang, North Kingstown, RI (US)

(73) Assignee: TORAY PLASTICS (AMERICA), INC., N. Kingstown, RI (US)

(21) Appl. No.: 13/902,362

(22) Filed: May 24, 2013

Related U.S. Application Data
(62) Division of application No. 13/601,423, filed on Aug. 31, 2012.

(51) Int. Cl. B05D 3/00

(52) U.S. Cl. CPC B05D 3/007
USPC 427/444

(57) ABSTRACT

A lidding film including a polyester film including a bio-based polyester, and an extrusion coated heat seal layer including a bio-based polymer. The polyester film may include a biaxially oriented core layer including bio-based polyester and an amorphous copolyester skin layer. The heat seal layer may include a low density polyethylene.

### CROSS-REFERENCE TO RELATED APPLICATION

This application is a divisional application of U.S. Ser. No. 13/601,423, filed Aug. 31, 2012, the entire contents of which are incorporated herein by reference.

### FIELD OF THE INVENTION

This invention relates to extrusion coated biaxially oriented films. More particularly, this invention relates to extrusion coated films including a bio-based sealant layer on a mono layer or multi-layer biaxially oriented bio-based polyolefin film.

### BACKGROUND OF THE INVENTION

Biaxially oriented polyolefin films are used for packaging, decorative, and label applications and often perform multiple functions. In particular, biaxially oriented polypropylene (BOPP), biaxially oriented polyester (BOPET) and biaxially oriented polyethylene (BOPE) films and laminations are popular, high performing, and cost-effective flexible substrates for a variety of food packaging applications. Such packaging films perform in a lamination to provide printability, transparent or matte appearance, or slip properties. They sometimes provide a surface suitable for receiving organic or inorganic coatings for gas and moisture barrier properties. These films also sometimes provide a heat sealable layer for bag forming and sealing, or a layer that is suitable for receiving an adhesive either by coating or laminating.

Bio-based polymers are derived from renewable or sustainable sources such as plants. Bio-based polymers are believed—once fully scaled-up—to reduce reliance on petroleum, and reduce production of greenhouse gases. Analysis studies demonstrate a significant reduction in greenhouse gas (“GHG”) emissions from the use of bio-based feedstock to produce polyesters such as PET have been presented in recent conferences. For example, Draths Corp. Technology presentation at BioPlastek 2011, stated that there was a 56% lower GHG emissions for the production of 100% bio-based PET vs. petroleum-based PET.

Bio-based polyethylene terephthalate and other polyesters differ from conventional petroleum-based polyesters in that ¹⁴C-isotope measurements show that the quantity of ¹⁴C in bio-sourced materials is significantly higher than in petroleum-based materials due to the continual uptake of this isotope by living plants and organisms. In petroleum-derived polyethylene terephthalate, however, ¹⁴C-isotope is essentially undetected using ASTM International standards (ASTM D6866). This is due to the half-life of ¹⁴C (about 5730±40 years) and the decay of this isotope over the hundreds of millions of years since the existence of the original organisms that took up said ¹⁴C, and turned into petroleum. Thus, bio-based or bio-sourced polyesters may be characterized by the amount of ¹⁴C they contain. The decay of ¹⁴C isotope is famously known for radiocarbon-dating of archeological, geological, and hydrogeological artifacts and samples and is based on its activity of about 14 disintegrations per minute (dpm) per gram carbon.

US Patent Publication No. 20090246430 states that “It is known in the art that carbon-14 (¹⁴C), which has a half life of about 5,700 years, is found in bio-based materials but not in fossil fuels. Thus, ‘bio-based materials’ refer to organic materials in which the carbon comes from non-fossil biological sources. Examples of bio-based materials include, but are not limited to, sugars, starches, corns, natural fibers, sugarcanes, beets, citrus fruits, woody plants, cellulosics, lignocelluosics, hemicelluloses, potatoes, plant oils, other polysaccharides such as pectin, chitin, levan, and pullulan, and a combination thereof . . . . As explained previously, the detection of ¹⁴C is indicative of a bio-based material. ¹⁴C levels can be determined by measuring its decay process (disintegrations per minute per gram carbon or dpm/gC) through liquid scintillation counting. In one embodiment of the present invention, the bio-based PET polymer comprises at least about 0.1 dpm/gC (disintegrations per minute per gram carbon) of ¹⁴C.” This is a useful definition of bio-based materials to distinguish them from their traditional petroleum-based counterparts.

US Patent Publication No. 20100028512 describes a method to produce bio-based polyester terephthalate (PET) resin which may then be used to make articles, containers, or packaging for food and beverage products. However, there is no description or suggestion regarding an extrusion coated sealant made of bio based polymers for lidding applications.

### SUMMARY OF THE INVENTION

Described are packaging articles such as lidding products, produced from bio-based films and bio-based extrusion coated sealants. A method for producing useful extrusion coated films using bio-based polyethylene terephthalate homopolymers and copolymers as a biaxially oriented base layer and bio-based polyethylene as a sealable layer is provided. The methods and bio-based articles may contain a certain amount of ¹⁴C-isotope, a quantity that is thus distinguishable from petroleum-based polyesters. These bio-based polyesters are made from, in turn, bio-based monomers, which are derived from plant-based intermediates such as alcohols and sugars.

In some embodiments, the at least partially bio-based high crystalline polyester core layer may include high intrinsic viscosity (IV) homopolyesters or copolyesters of polyethyleneterephthalate, polyethylene naphthalate, polybutylene terephthalate, polytrimethylene terephthalate, polyethylene terephthalate-co-isophthalate copolymer, polyethylene terephthalate-co-naphthalate copolymer, polycyclohexylene terephthalate, polyethylene-co-cyclohexylene terephthalate, etc. and other ethylene glycol or terephthalic acid-based polyester homopolymers and copolymers and blend combinations thereof (and alike polyester copolymers).

In some embodiments, the at least partially bio-based high crystalline polyester core layer may include an intrinsic viscosity of about 0.50 to about 0.60. In some embodiments, the at least partially bio-based crystalline polyester core layer includes an intrinsic viscosity of greater than about 0.60.

Some embodiments may include an at least partially bio-based amorphous copolyester first skin layer that includes isophthalate modified copolyesters, sebacic acid modified copolyesters, diethyleneglycol modified copolyesters, triethyleneglycol modified copolyesters, cyclohexanedimethanol modified copolyesters, and mixtures and combinations thereof.

The bio based polyester film's thickness may range from 5 microns to 100 microns. More specifically from 5 microns to 75 microns, more specifically from 5 to 50 microns.

In some embodiments, the bio-based extrusion coated polyethylene includes bio-based propylene copolymers, polyester copolymers, terpolymers, polyethylene, and/or combinations thereof.

The bio-based extrusion coated sealant may range in thickness from 5 microns to 200 microns. More specifically from 5 microns to 100 microns, more specifically from 5 microns to 50 microns.

The amount of bio-based content of the polyester can be characterized using test procedure ASTM D6866 which measures the amount of ¹⁴C isotope (also known as “radiocarbon”) in said polyester and compares it to a modern reference standard. This ratio of measured ¹⁴C to the standard can be reported as “percent modern carbon” (pMC). Petroleum or fossil fuel-based polyester will have essentially 0% radiocarbon (0 pMC) whereas contemporary 100% bio-based or bio-mass polyester should have about or near 100% radiocarbon (105.3 pMC). It is preferable that the ratio of biomass-based polyester in the high crystalline polyester film layer be at least equivalent to 1 pMC, and more preferably 19 pMC, and even more preferably about 105.3 pMC.

The amount of bio-based content of the polyethylene can be characterized using test procedure ASTM D6866 which measures the amount of ¹⁴C isotope (also known as “radiocarbon”) in said polyethylene and compares it to a modern reference standard. This ratio of measured ¹⁴C to the standard can be reported as “percent modern carbon” (pMC). Petroleum or fossil fuel-based polyester will have essentially 0% radiocarbon (0 pMC) whereas contemporary 100% bio-based or bio-mass polyethylene should have about or near 100% radiocarbon (105.3 pMC). It is preferable that the ratio of biomass-based carbon to petroleum-based carbon in the polyethylene film layer be at least 1 pMC, and more preferably 90 pMC, and even more preferably, about 105.3 pMC.

A primer may be used to facilitate bonding of the skin layer. This primer may be water-based or solvent based. An example of a primer that may be used is a 1 wt % solution of a water based, modified polyethylenimine resin dispersion that can be applied to a freshly corona treated polyester layer at an application weight of 0.62 g/sq-m on a wet solution basis. The coating can be dried in a convective oven at about 160 F to give a theoretical dry coating weight of about 1% of the wet weight.

In one embodiment, a lidding film includes a polyester film including a bio-based polyester; and an extrusion coated heat seal layer comprising a bio-based polymer. The polyester film may have a radiocarbon content of at least 19 pMC. The heat seal layer may include low density polyethylene. The low density polyethylene may have a radiocarbon content of at least 94 pMC. The heat seal layer may have a thickness of between 5 μm to 200 μm.

The polyester film may include a biaxially oriented core layer comprising bio-based polyester. The core layer may include a bio-based polyester with a crystallinity of >35% weight fraction. The polyester film further comprises at least one amorphous copolyester skin layer. The polyester film may have a total thickness of 5 μm to 100 μm. In some embodiments, the biaxially oriented core layer consists or consists essentially of polyethylene terephthalate and has a radiocarbon content of at least 19 pMC.

In some embodiments, the biaxially oriented core layer may be co-extruded with an amorphous copolyester skin layer. The amorphous copolyester skin layer may have a melting point of less than 210° C. The amorphous copolyester skin layer include, for example, isophthalate modified copolyesters, sebacic acid modified copolyesters, diethyleneglycol modified copolyesters, triethyleneglycol modified copolyesters, cyclohexanedimethanol modified copolyesters, or polyethylene 2,5-furanedicarboxylate.

In some embodiments, the heat seal layer may include low density polyethylene that has a radiocarbon content of at least 94 pMC.

An embodiment of a method of making a lidding film may include extruding a polyester film comprising a bio-based polyester, and extrusion coating a heat seal layer comprising a bio-based polymer on the polyester film. The method may further include biaxally orienting the polyester film.

### DETAILED DESCRIPTION OF THE INVENTION

Described are extrusion coated films including a bio-based sealant layer on a mono layer or multi-layer biaxially oriented bio-based polyolefin film. Also described are methods of extrusion coating bio-based sealant layers onto mono layer and multi-layer biaxially oriented polyolefin films. The polyolefin films may be formed, for example, from novel bio-based propylene copolymers, polyester copolymers, terpolymers, polyethylene, and/or combinations thereof. The bio-based extrusion coated sealant layer may be made of propylene copolymers, terpolymers, polyethylene, and/or combinations thereof. The extrusion coated layer may include an antiblock component, for example, amorphous silica, aluminosilicate, sodium calcium aluminum silicate, crosslinked silicone polymer, polymethylmethacrylate, and/or blends thereof.

One particular embodiment of such a bio based polyolefin film is polyethylene terephthalate or polyester (abbreviated as “PET”) homopolymer or copolymer with one or both of its major monomer building blocks, terephthalic acid or ethylene glycol, derived from biological sources.

These extrusion coated films exhibit excellent properties, including heat seal strength and hot tack, substantially equivalent to their petroleum-based counterparts, while being derived from non-petroleum sources. These articles can be used in lidding applications where heat resistance and heat seal properties are combined with an environmentally friendly packaging choice.

In embodiments, polyester films having at least partially bio-based content are extrusion coated with bio based extrusion coated sealants to be used for food packaging lidding applications.

A polyester film may include a core layer of highly crystalline, at least partially bio-based polyester layer and an amorphous skin layer, optionally at least partially bio-based. Crystallinity is defined as the weight fraction of material producing a crystalline exotherm when measured using a differential scanning calorimeter. For a high crystalline polyester, an exothermic peak in the melt range of 220° C. to 290° C. is most often observed. High crystallinity is therefore defined as the ratio of the heat capacity of material melting in the range of 220° C. to 290° C. versus the total potential heat capacity for the entire material present if it were all to melt. A crystallinity value of >35% weight fraction is considered high crystallinity.

Preferably, the thickness of the polyester film is 5-100 μm. The structure also includes a heat seal layer, for example, an extrusion coated bio based linear low density polyethylene (LLDPE). The thickness of the extrusion coating is preferably between 5-200 μm.

### The Polyester Film

The materials selected for the various layers of the polyester film can include any suitable material. For example, in embodiments, the polyester film may include an at least-partially bio-based high crystalline core layer including polyethylene terephthalate, polyethylene naphthalate, polyethylene 2,5-furandicarboxylate, mixtures, copolymers and combinations thereof. Further, in some embodiments, the polyester film further includes an coextruded skin layer that includes an at least partially bio based amorphous polyester selected from polyethylene terephthalate, polybutylene terephthalate, polypropylene terephthalate, polyethylenenaphthalate, mixtures, copolymers and combinations thereof, polyethylene terephthalate-co-isophthalate, poly(ethylene-co-1,4 cyclohexyldimethylene)terephthalate, and polyethylene 2,5-furandicarboxylate.

The core layer may be formed from a bio-based crystalline polyester resin that can be polymerized by polycondensation between two or more building blocks with diacid and diester functionality, at least one of which is plant-sourced. One process or method to produce such plant-sourced monomer, namely ethylene glycol, is to ferment sugar cane or other plant sugars and starches and distill into ethanol (CH3-CH2-OH). Through a dehydration process using mineral acids, strong organic acids, suitable catalysts and combinations thereof, the ethanol can be converted to ethylene monomer (CH2=CH2), which in turn can be oxidized into ethylene oxide

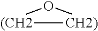

from which ethylene glycol (HO—CH2-CH2-OH) is derived by hydrolysis. One convenient low-cost source of sugar is the molasses generated as a by-product during the manufacture of sugar.

Diacids can also be derived from plant sources. For example there are several routes published for deriving terephthalic acid from biomass. Some of those routes are described in US Patent Application 2009/0246430 A1: one route involves extracting limonene from at least one bio-based material (for example citrus fruit peels), converting the limonene to at least one terpene, converting the terpene to p-cymene, and oxidizing the p-cymene to terephthalic acid:

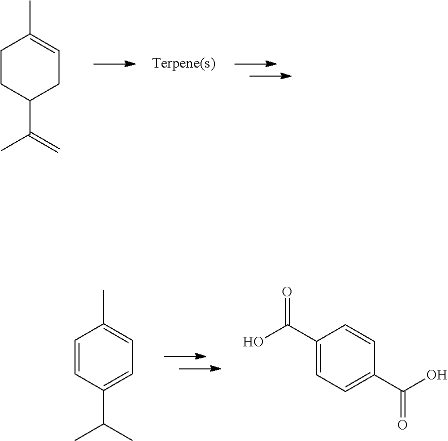

Another possible route to bio-terephththalic acid described in US Patent Publication No. 2009/0246430 A1 is through extraction of hydroxymethylfurfural from a bio-based material, such as corn syrup, sugars, or cellulose, converting hydroxymethylfurfural to a first intermediate, reacting the first intermediate with ethylene (which can also be derived from bio-sources such as described in paragraph 23) to form a second intermediate, treating the second intermediate with an acid in the presence of a catalyst to form hydroxymethyl benzaldehyde and oxidizing hydroxymethylbenzaldehyde to terephthalic acid.

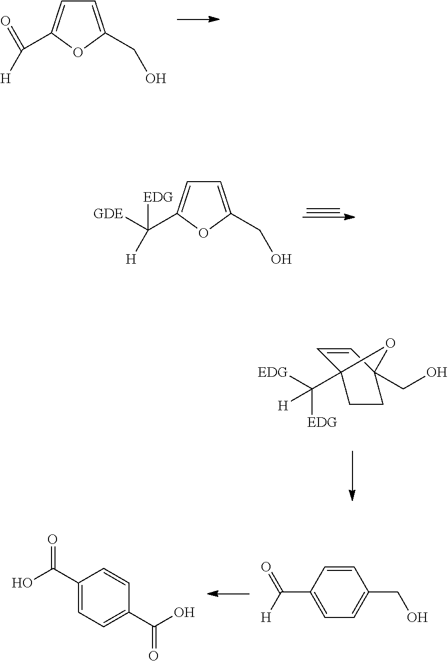

Another bio-derivative of plant-based hydroxymethylfurfural is 2,5-furandicarboxylic acid,

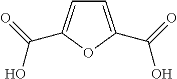 [SMILES: O=C(O)c1ccc(C(=O)O)o1]

(FDCA) derived by a catalytic oxidation.

FDCA can be used as the bio-diacid source for preparing the polyester films. For example, condensation of FDCA with ethylene glycol provides polyethylene 2,5-furanedicarboxylate (PEF); preparation and physical properties of PEF are described by A. Gandini et al. (Journal of Polymer Science Part A: Polymer Chemistry Vol. 47, 295-298 (2009): its melting and crystallization behavior follow the same pattern as those of PET (i.e. a crystallization rate slow enough for its melt to be able to be quenched into the amorphous state but high enough to enable achieving high crystallinity by heating from amorphous or cooling from the melt; these attributes are essential for a drop-in adaptation in a PET-type biaxially oriented film manufacturing process), with a glass transition temperature (following quenching) at 75-80° C. and a melting temperature of 210° C. (45° C. lower than that of PET). A conference presentation by the Avantium Company (“Avantium's YXY: Green Materials and Fuels”, 2^{nd} Annual Bio-Based Chemicals Summit, Feb. 15, 2011) reports that PEF has been processed into bottles and film with superior gas and moisture barrier properties vs. PET. This presentation, however, does not disclose using PEF in multilayer lidding films and does not mention taking advantage of the lower melting temperature of PEF for the purpose of utilizing it in the heat-sealable layer of a coextruded film. A bio-based PEF film material can have pMC ranging between about 79.0 and 105.3 depending on whether only the FDCA component or both the FDCA and EG are bio-sourced.

Another route towards bio-based terephthalic acid is through the intermediate preparation of trans, trans muconic acid

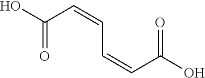

from biomass. A preparation method for cis, cis and cis, trans muconic acid from biomass (such as starches, sugars, plant material, etc.) through the biocatalytic conversion of glucose and others sugars contained therein, is described in U.S. Pat. No. 5,616,496. A subsequent isomerization of the above isomer mix into trans, trans muconic acid, necessary for conversion into terephthalic acid by reacting with dienophiles is described in US patent application 20100314243 by Draths Corporation.

Yet another route towards bio-based terephthalic acid is converting carbohydrates derived from corn or sugarcane and potentially from lignocellulosic biomass into bio-isobutanol via fermentation by employing appropriate yeasts. Such processes are described for example in US Patent Applications 20090226991 and 20110076733 by Gevo, Inc. The biologically-sourced isobutanol in turn is converted to para-xylene through a series of intermediate steps, according to procedures such as those described in US patent application 20110087000 by Gevo Inc. The bio-sourced para-xylene in turn is oxidized to bio-terephthalic acid through commercially known oxidation/purification processes.

In one set of embodiments, the bio-based film core layer is a crystalline polyethylene terephthalate and can be uniaxially or biaxially oriented. These resins have intrinsic viscosities between 0.60 and 0.85 dl/g, a melting point of about 255-260° C., a heat of fusion of about 30-46 J/g, and a density of about 1.4. The pMC value of these crystalline polyesters is preferably at least about 20.3, and more preferably about 105.3.

For the embodiments in which the biaxially oriented multilayer bio-based polyester is PET-based, the coextrusion process may include a two- or three-layered compositing die. In general, a preferred extrusion process for producing the polyester film, masterbatch and crystallizable polyester feed particles are dried (preferably less than 100 ppm moisture content) and fed to a melt processor, such as a mixing extruder. The molten material, including the additives, may be extruded through a slot die at about 285° C. and quenched and electrostatically-pinned on a chill roll, whose temperature is about 20° C., in the form of a substantively amorphous prefilm. The film may then be reheated and stretched longitudinally and transversely; or transversely and longitudinally; or longitudinally, transversely, and again longitudinally and/or transversely. The preferred is sequential orientation of first longitudinally, then transversely. It can also be contemplated to orient the film simultaneously in both the longitudinal and transverse dimensions as some film-making processes allow. The stretching temperatures are generally above the glass transition temperature of the film polymer by about 10 to 60° C.; typical machine direction processing temperature is about 95° C. Preferably, the longitudinal stretching ratio is from 2 to 6 times the original longitudinal dimension, more preferably from 3 to 4.5. Preferably, the transverse stretching ratio is from 2 to 5 times the original transverse dimension, more preferably from 3 to 4.5 with typical transverse direction processing temperature about 110° C. Preferably, any second longitudinal or transverse stretching is carried out at a ratio of from 1.1 to 5 times. The first longitudinal stretching may also be carried out at the same time as the transverse stretching (simultaneous stretching). Heat setting of the film may follow at an oven temperature of about 180 to 260° C., preferably about 220 to 250° C., typically at 230° C., with a 5% relaxation to produce a thermally dimensionally stable film with minimal shrinkage. The film may then be cooled and wound up into roll form.

The heat-sealable amorphous polyester skin may be a bio-based PET copolymer or a bio-based PEF homopolymer, comprising at least about 20.3 pMC, and preferably about 90.1 pMC. A bio-based PET copolymer will preferably comprise a terephthalate-co-isophthalate copolymer with ethylene glycol, and further preferably, comprising of at least 20.3 pMC. In the embodiment in which this layer comprises a non-heat sealable, winding layer, this layer will comprise a crystalline PET with anti-blocking and/or slip additives. Optionally, said winding layer is comprised of at least about 20.3 pMC bio-based polyesters.

### Seal Layer

The film preferably includes an extrusion coated polyolefin layer, which provides the low-melt temperature seal layer necessary for optimal sealing in lidding applications. The preferred heat seal ranges (measured at 0.5 seconds dwell and 30 pounds per square inch pressure) may be between 75 degrees C. and 235 degrees C., more preferably between 100 degrees C. and 200 degrees C.

The bio-based extrusion coated sealant layer may be made of bio based propylene copolymers, terpolymers, polyethylene, and/or combinations thereof.

Preferably the polyolefin comprises polyethylene (PE), preferably low density polylethylene (LDPE), and even more preferably, linear low density polyethylene (LLDPE). The LLDPE layer is bio-based. Bio-based polyethylene uses as its major ethylene monomer component derived from sugar cane or corn starches (which were subsequently fermented to ethanol or methanol and converted to ethylene). Whereas ethylene is the major monomer in LLDPE, additional co-monomers (higher alpha-olefins such as butene, hexene, octene) are used to control the density and other physical properties and are added at typical levels between 3 and 15 wt. %. If only the ethylene portion is bio-based, this comonomer inclusion would reduce the pMC from the maximum value of 105.3 to a value corresponding to the percentage of ethylene repeat units, which can be present at levels between 85-97 wt. %. Commercial examples of bio-based LLDPE are the “I'm Green”™ line of bio-polyethylenes from BRASKEM SA, for example grades SLL118, SLL118/21, SLL218, SLL318, SLH118, SLH0820/30AF, SLH218), having published bio-carbon content around 89-90% (pMC level 93.7-94.8).

The extrusion-coated polyethylene layer, which is activated by heat sealing at a temperature above the melting point of polyethylene but below the melting point of PET, is a preferred method of providing good seal performance. This invention utilizes a bio based extrusion-coated polyethylene layer which has been coated on the bio based polyolefin film.

The extrusion coated bio based sealant layer can include additives. Preferred additives in the layer include antiblock and slip additives. These are typically solid particles dispersed within the layer effectively to produce a low coefficient of friction on the exposed surface of the sealant layer. This low coefficient of friction helps the film to move smoothly through the film formation, stretching and wind-up operations. Without such antiblocking and slip additives, the outer surfaces would be more tacky and would more likely cause the film being fabricated to stick to itself and to processing equipment causing excessive production waste and low productivity. Examples of antiblock and slip additives that may be used include amorphous silica particles with mean particle size diameters in the range of 0.050-0.1 μm at concentrations of 0.1-0.4 weight percent of the layer; and/or calcium carbonate particles with a medium particle size of 0.3-1.2 μm at concentrations of 0.03-0.2 weight percent of the layer. Precipitated alumina particles of sub-micron sizes may also be used, either alone or blended with other antiblock types, with an average particle size, for example, of 0.1 μm and at a weight percent of 0.1-0.4 of the layer. Additional examples include, but are not limited to, inorganic particles, aluminum oxide, magnesium oxide, and titanium oxide; such complex oxides as kaolin, talc, and montmorillonite; such carbonates as calcium carbonate and barium carbonate; such sulfates as calcium sulfate and barium sulfate; such titanates as barium titanate and potassium titanate; and such phosphates as tribasic calcium phosphate, dibasic calcium phosphate, and monobasic calcium phosphate. Two or more of these may be used together to achieve a specific objective. As examples of organic particles, vinyl materials as polystyrene, crosslinked polystyrene, crosslinked styrene-acrylic polymers, crosslinked acrylic polymers, crosslinked styrene-methacrylic polymers, and crosslinked methacrylic polymers, as well as such other materials as benzoguanamine formaldehyde, silicone, and polytetrafluoroethylene may be used or contemplated.

The extrusion coated sealant is applied as a molten resin curtain onto the base polymeric film. The temperature range of this molten resin curtain depends on the type of resin used but generally is between 175 degrees C. and 350 degrees C. This molten curtain is cooled as soon as it contacts the polymeric film since a chill roll supports the base film. The chill roll is usually kept at temperatures between 50 degrees C. and 20 degrees C. The extrusion coated sealant of this invention will have thickness that ranges from 5 microns to 200 microns. More specifically from 5 microns to 75 microns, more specifically from 5 to 50 microns.

A primer may be used to facilitate bonding of the seal layer. This primer may be water-based or solvent based. An example of a primer that may be used is a 1 wt % solution of a water based, modified polyethylenimine resin dispersion that can be applied to a freshly corona treated polyester layer at an application weight of 0.62 g/sq-m on a wet solution basis. The coating can be dried in a convective oven at about 160 F to give a theoretical dry coating weight of about 1% of the wet weight.

Flexographic or Rotogravure printing may be used to print graphic designs on the non sealable side of this construction. The side of the film opposite the sealant layer may be printed with up to 20 colors of ink. Each color receives some drying prior to application of the subsequent color. After print application, the inks may be fully dried in a roller convective oven to remove all solvents from the ink prior to winding up and subsequent downstream operations.

### Test Methods

Intrinsic viscosity (IV) of the film and resin were tested according to ASTM D460. This test method is for the IV determination of poly(ethylene terephthalate) (PET) soluble at 0.50% concentration in a 60/40 phenol/1,1,2,2-tetrachloroethane solution by means of a glass capillary viscometer.

Melting point of polyester resin is measured using a TA Instruments Differential Scanning Calorimeter model 2920. A 0.007 g resin sample is tested, using ASTM D3418-03. The preliminary thermal cycle is not used, consistent with Note 6 of the ASTM Standard. The sample is then heated up to 280° C. temperature at a rate of 10° C./minute, then cooled back to room temperature while heat flow and temperature data are recorded. The melting point is reported as the temperature at the endothermic peak located in the temperature range between of 150 and 280° C.

The melt volume resistivity of the resin was measured by placing 14 grams of the material in a test tube, and then placing the tube in a block heater until the material completely melted (typically in 2-3 minutes). Next, parallel thin metal probes connected to a resistometer were dipped into the melt and the resistance was measured.

Radiocarbon/biomass content pMC was measured substantially in accordance with ASTM D6866-10 “Renewable Carbon Testing” procedure. Analytical methods used to measure ¹⁴C content of respective bio-based and petroleum-based polyolefin materials and articles made include Liquid Scintillation Counting (LSC), Accelerator Mass Spectrometry (AMS), and Isotope Ratio Mass Spectroscopy (IRMS) techniques. Bio-based content is calculated by deriving a ratio of the amount of radiocarbon in the article of interest to that of the modern reference standard. This ratio is reported as a percentage of contemporary radiocarbon (pMC or percent modern carbon) and correlates directly to the amount of biomass material present in the article.

Wetting tension of the surfaces of interest was measured substantially in accordance with ASTM D2578-67. In general, the preferred value was an average value equal to or more than 40 dyne/cm with a minimum of 36 dyne-cm/cm²; and more preferably 48-68 dyne-cm/cm².

Sealing strength of the lidding article was measured as following. The seal layer is sealed to a rigid substrate such as a CPET or Polypropylene tray using a Sentinel heat sealer. The heat seal conditions are 350° F. (177° C.) temperature, 0.5 seconds dwell time, and 30 psi (ca. 0.207 N/mm²) jaw pressure, 1 heated jaw. Prior to peeling, the sealed materials are cut so that each web can be gripped in a separate jaw of the tensile tester and 1′×⅜″ (305 mm×9.5 mm) section of sealed material can be peeled. The two surfaces are peeled apart on an Instron tensile tester in a 90° configuration known as a T-peel. The peel is initiated at a speed of 2″/minute (ca. 51 mm/min) until 0.5 lbsf (2.22 N) of resistance is measured to preload the sample. Then the peel is continued at a speed of 6″/minute (ca. 152 mm/min) until the load drops by 20%, signaling failure. The maximum recorded load prior to failure is reported as the seal strength.

### Example 1

A 70 gauge (18 μm) two-layer polyester film was prepared by co-extruding a skin layer from amorphous copolyester type 8906C from Invista adjacent to one side of a core layer from the aforementioned bio-PET extruded melt stream I, at a skin/core weight ratio of 3.8%. The extrudate was cast on a cooling drum and subsequently stretched longitudinally at 250° F. (121° C.) by a ratio of 4.8 and then transversely at 240° F. (115.5° C.) by a ratio of 4.2 and heat-set at 460° F. (238° C.). The resulting thickness of the coextruded and oriented amorphous skin layer was about 0.5 μm.

The non-sealable surface of the film was corona-treated and was coated with a solution of polyethyleneimine-based resin (Mica A-131-X) using a gravure coater. The anchor layer was dried in a convective dryer. The dried anchor surface was then extrusion-coated with petroleum-based LLDPE (Dow's Elite® 5815, 20 μm thick), at a temperature of 600° F. (315.5° C.). This packaging article was sealed to a rigid polypropylene tray at 350° F. (177° C.) and pulled to measure seal strength.

### Example 2

Example 1 was repeated with the exception that in place of the fossil-fuel-based LLDPE used in example 1 (Dow's Elite® 5815, melt index 15 g/10 min), a bio-based LLDPE (grade SLL 218 from Braskem, melt index 2) was used.

### Comparative Example 1

The base film for comparative example 1 was a fossil-fuel-based PET resin with IV (0.65) and melt resistivity (0.18 MΩ·m) was used (namely 48ga PA10 from Toray Plastics). The resulting thickness of this base film was 12 μm. The sealable layer was made with Braskem's bio based LLDPE grade SLL 218. The resulting thickness of this bio based extruded sealable layer was 20 μm.

### Comparative Example 2

The base film for comparative example 2 was a fossil-fuel-based PET resin with IV (0.65) and melt resistivity (0.18 MΩ·m) was used (namely 48ga PA10 from Toray Plastics). The resulting thickness of this base film was 12 μm. The sealable layer was made with Dow's Elite® 5815. The resulting thickness of this petroleum based extruded sealable layer was 20 μm.

TABLE 1

| | | | Comparative | Comparative |
|---|---|---|---|---|
| | Example 1 | Example 2 | Example 1 | Example 2 |
| Tensile Strength | 18,926 | 27,384 | 19,648 | 16,810 |
| MD (psi) | | | | |
| Elongation MD | 136 | 146 | 139 | 124 |
| (%) | | | | |
| Young's | 260,996 | 283,064 | 290,535 | 240,369 |
| Modulus MD | | | | |
| (psi) | | | | |
| COF (seal/metal | 0.3 | 0.25 | 0.27 | 0.35 |
| plate) | | | | |
| Sealing Strength | 265 | 291 | 275 | 297 |
| to PP tray @ | | | | |
| 350 F., 0.5 sec | | | | |
| 30 psi (gm/in) | | | | |

As the results show, both the bio based polyester film with bio based sealant and the bio based polyester film with petroleum based sealant are fit for use in lidding applications as they provide comparable performance to more traditional lidding technology.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1. A method of making a lidding film comprising:
extruding a polyester film comprising a bio-based polyester; and
extrusion coating a heat seal layer comprising a bio-based polymer on the polyester film.

2. The method of claim 1, further comprising biaxally orienting the polyester film.

3. The method of claim 1, wherein the polyester film has a radiocarbon content of at least 19 pMC.

4. The method of claim 1, wherein the heat seal layer comprises low density polyethylene.

5. The method of claim 4, wherein the low density polyethylene has a radiocarbon content of at least 94 pMC.

6. The method of claim 1, wherein the heat seal layer has a thickness of between 5 μm to 200 μm.

7. The method of claim 1, wherein extruding a polyester film comprises coextruding a core layer comprising bio-based polyester with a crystallinity of >35% weight fraction and at least one amorphous copolyester skin layer to form the polyester film.

8. The method of claim 7, wherein the polyester film has a total thickness of 5 μm to 100 μm.

9. The method of claim 7, wherein the biaxially oriented core layer consists essentially of polyethylene terephthalate and has a radiocarbon content of at least 19 pMC.

10. The method of claim 7, wherein the amorphous copolyester skin layer has a melting point of less than 210° C.

11. The method of claim 7, wherein the amorphous copolyester skin layer comprises isophthalate modified copolyesters, sebacic acid modified copolyesters, diethyleneglycol modified copolyesters, triethyleneglycol modified copolyesters, cyclohexanedimethanol modified copolyesters, or polyethylene 2,5-furanedicarboxylate.

12. The method of claim 7, wherein the heat seal layer comprises low density polyethylene that has a radiocarbon content of at least 94 pMC.
